(19) United States
(12) Patent Application Publication
(10) Pub. No.: US 2009/0301645 A1
(43) Pub. Date: Dec. 10, 2009

(54) SYSTEM AND METHOD OF JOINING COMPONENTS

(75) Inventor: Eklavya Calla, Bangalore (IN)

Correspondence Address: CANTOR COLBURN, LLP, 20 Church Street, 22nd Floor, Hartford, CT, 06103, US

(73) Assignee: General Electric Company, Schenectady, NY (US)

(21) Appl. No.: 12/132,724

(22) Filed: Jun. 4, 2008

(51) Int. Cl. B32B 37/00

(52) U.S. Cl. 156/182; 156/390

(57) ABSTRACT

A method of joining components includes applying a first coating to a first surface of a first component. The first coating is cold sprayed onto the first surface. The method also includes applying a second coating to a second surface of a second component. The second coating is cold sprayed onto the second surface. The first surface of the first component is adjoined to the second surface of the second component to form an interface zone. A liquid layer, including at least a portion of the first and second coatings is formed at the interface zone and then solidified to form a bond between the first and second components.

### BACKGROUND OF THE INVENTION

The present invention pertains to the art of cold spray coatings and, more particularly, to a system and method of joining components having cold spray coated surfaces.

Conventionally, cold spray techniques are employed to provide a surface treatment to a component. Cold spray techniques are employed when it is desired to apply a coating material without adding heat or the like to affect a bond between the component to be coated and the coating material. Other applications for cold spraying include constructing free-form structures.

### BRIEF DESCRIPTION OF THE INVENTION

In accordance with an exemplary embodiment of the invention, a method of joining components includes applying a first coating to a first surface of a first component. The first coating is cold sprayed onto the first surface. The method also includes applying a second coating to a second surface of a second component. The second coating is cold sprayed onto the second surface. The first surface of the first component is adjoined to the second surface of the second component to form an interface zone. A liquid layer, including at least a portion of the first and second coatings is formed at the interface zone and then solidified to form a bond between the first and second components.

In accordance with another exemplary embodiment of the present invention, a system for joining components includes a cold spray device operatively connected to coating source. The cold spray device deposits a first coating onto a first surface of a first component and a second coating on a second surface of a second component. The system further includes a treating device housing the first and second component with the first surface of the first component being adjoined to the second surface of the second component to form an interface zone. The treating device, when operated, creates a liquid layer at the interface zone. The liquid layer includes a portion of the first and second coatings. The treating device also solidifies the liquid layer to form a bond between the first and second components.

Additional features and advantages are realized through the techniques of exemplary embodiments of the present invention. Other exemplary embodiments and aspects of the invention are described in detail herein and are considered a part of the claimed invention. For a better understanding of the invention with advantages and features thereof, refer to the description and to the drawings.

### BRIEF DESCRIPTION OF THE DRAWINGS

FIG. 1 is a schematic view of a components joining system including a cold spray coating device and a treating device in accordance with an exemplary embodiment of the invention;

FIG. 2 is a partially cut-away schematic view of first and second components positioned within the treating device of the component joining system in accordance with an exemplary embodiment of the invention; and

FIG. 3 is a block diagram illustrating a method of joining components having cold spray coated surfaces in accordance with an exemplary embodiment of the invention.

### DETAILED DESCRIPTION OF THE INVENTION

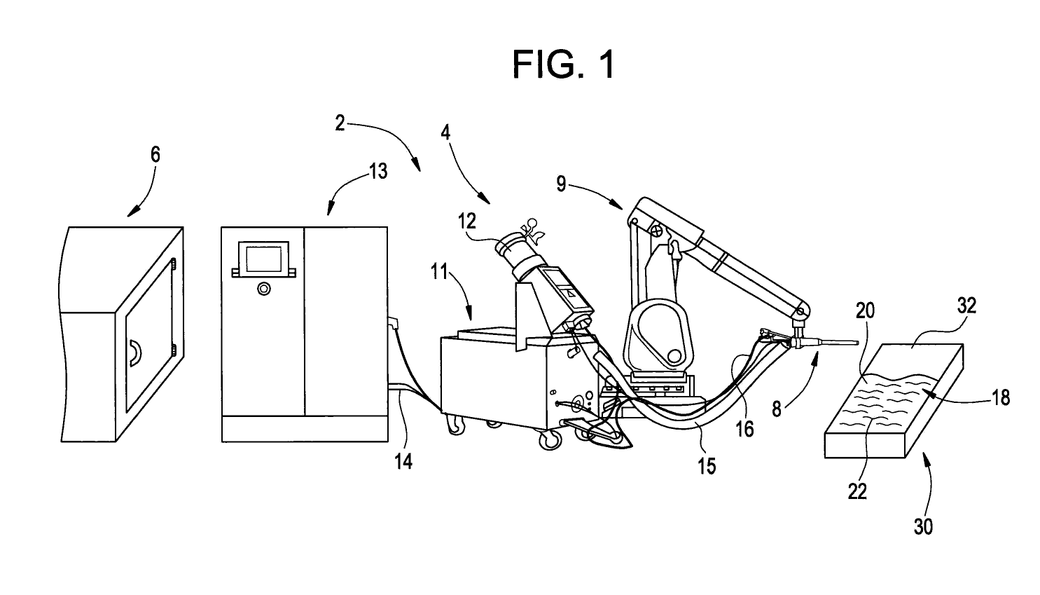

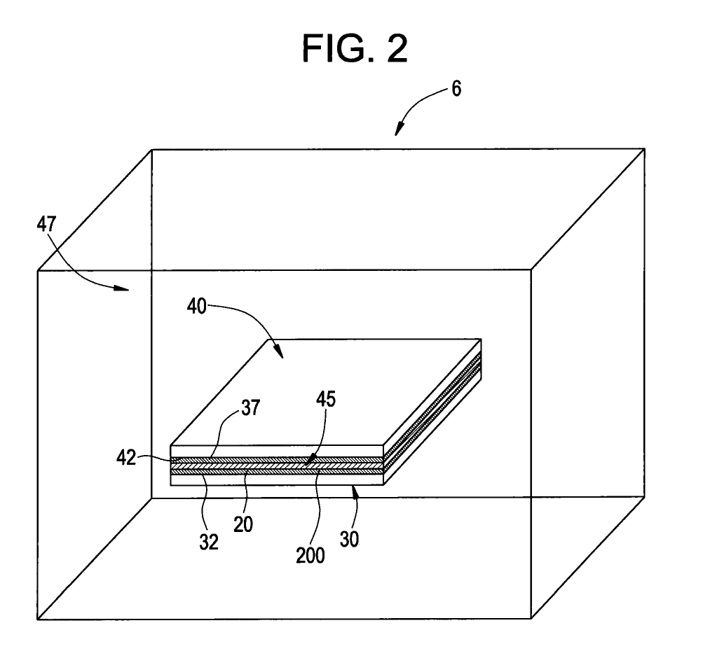

With initial reference to FIGS. 1 and 2, a component joining system constructed in accordance with an exemplary embodiment of the invention is indicated generally at 2. Joining system 2 includes a cold spray coating device 4 and a treating device 6. Cold spray coating device 4 includes a cold spray gun 8 mounted to a robot arm 9. Of course, gun 8 could also be hand held or manipulated by various other mechanical devices. Cold spray gun 8 is operatively connected to a gas heater 11 including a powder hopper 12. Of course it should be understood that powder hopper 12 could be a separate unit from gas heater 11. Gas heater 11 receives a supply of gas from a gas control module 13 via a hose 14. A portion of the supply of gas from gas control module 13 is diverted to powder hopper 12 to serve as a carrier for the powder. The gas and powder is then directed to gun 8 via first and second hoses 15 and 16. Hose 15 delivers gas to gun 8 while hose 16 delivers the powder from powder hopper 12. At this point, the gas and powder are directed onto a component to form a coating. Towards that end, cold spray gun 8 includes a nozzle which, depending upon a desired application, takes the form of a converging/diverging nozzle or a non-converging/diverging nozzle, that accelerates the gas and powder to a high speed for delivery onto a substrate. The gas forced the powder onto the substrate at speeds, typically in a range of between 800 m/s to 900 m/s. The high speed delivery forces the powder or coating material to adhere to the component and form a coating as will be discussed more fully below. Of course it should be understood that delivery speeds can vary to levels below 800 m/s and above 900 m/s depending on desired adhesion characteristics.

In accordance with an exemplary embodiment of the invention, cold spray device 4 deposits a first coating material 18 having a primary coating substance 20 and a secondary coating substance 22 onto a first component 30. In further accordance with the exemplary embodiment, secondary coating substance 22 is a melting point depressing agent such as boron or silicon which, as will become more fully evident below, facilitate creation of a bond. In addition to coating first component 30, a second coating material 37 is applied to a second component 40 (FIG. 2). In a manner similar to that described above, second coating material 37 includes a primary coating substance and a secondary coating substance or melting point depressing agent (not separately labeled). Second coating material 37 is applied to a second surface 42 of second component 40. Once coated, the first and second surfaces are adjoined to establish an interface zone 45, and placed within an interior chamber 47 of treating device 6. As will be detailed more fully below, treating device 6, when operated, facilitates the formation of a bond between first and second components 30 and 40.

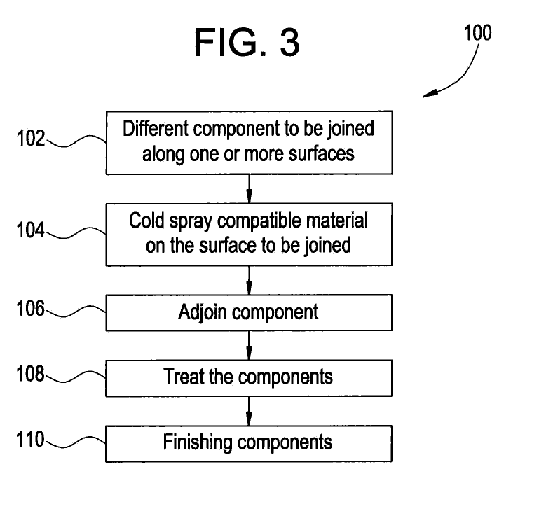

Reference will now be made to FIG. 3 in describing a method 100 of joining components 30 and 40 in accordance with an exemplary embodiment of the invention. As indicated in block 102, different parts that require joining along one or more surfaces are placed at cold spray coating device 4. A compatible coating material 18, 37 is cold sprayed onto respective ones of the surfaces, e.g., 32, 42, to be joined as indicated on block 104. For example, when coating nickel alloys, a coating material containing nickel would be utilize, when coating cobalt based alloys, a coating material including cobalt would be employed etc. Once coated, surfaces 32 and 42 are brought into close contact, i.e., components 30 and 40 are adjoined along coated surfaces 32 and 42, as indicated in block 106. At this point, components 30 and 40 are moved into treating device 6. Treating device 6 is operated to treat, e.g., heat treat, components 30 and 40. In accordance with one exemplary aspect of the invention, treating device 6 heats components 30 and 40 to a temperature that is above the melting point of first and second coating materials 18 and 37 and below the melting point of components 30 and 40 as indicated in block 108. As the temperature rises within interior chamber 47, a liquid zone 200 (FIG. 2) develops at interface zone 45.

Liquid zone 200 grows or advances throughout interfaces zone 45 consuming first and second coating materials 18 and 37 and, ultimately a portion of each adjoined surface, e.g., first surface 32 and second surface 42. As each coating material 18, 37 is consumed, liquid zone 200 also consumes secondary coating substance or melting depressing material 22. As secondary coating substance 22 continues to be consumed, liquid zone 200 begins to solidify. That is, the loss of secondary coating substance or melting point depressing agent 22 raises the melting point of liquid zone 200 above the temperature in interior chamber 47. Once all or substantially all of secondary coating substance 22 is consumed, liquid zone 200 solidifies thereby creating a diffusion bond (not separately labeled) between first and second components 30 and 40. Cold spraying results in a higher rate of diffusion and/or diffusion occurring at a lower temperature then what it usually the case for materials that are deposited using a different process.

At this point it should be appreciated that exemplary embodiments of the present invention can be employed to form a high quality bond between similar and/or dissimilar materials. Depending on the type of components to be joined, various cold spray coatings and melting depressing agents can be employed. Once the components are joined, if desired, the bond is subjected to a finishing process. More specifically, depending on the particular application for components 30 and 40 the bond is subjected to a grinding process, a polishing process and/or a stress relieving process to provide a desired final finish.

In general, this written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of exemplary embodiments of the present invention if they have structural elements that do not differ from the literal language of the claims, or if they include equivalent structural elements with insubstantial differences from the literal language of the claims.

1. A method of joining components, the method comprising:
applying a first coating to a first surface of a first component, the first coating being cold sprayed onto the first surface;
applying a second coating to a second surface of a second component, the second coating being cold sprayed onto the second surface;
adjoining the first surface of the first component and the second surface of the second component to form an interface zone;
forming a liquid layer at the interface zone, the liquid layer including at least a portion of the first coating and a portion of the second coating; and
solidifying the liquid layer to form a bond between the first and second components.

2. The method of claim 1, wherein forming the liquid layer includes growing the liquid layer at the interface zone to include at least a portion of one of the first and second components.

3. The method of claim 2, wherein forming the liquid layer includes growing the liquid layer at the interface zone to include a portion of each of the first and second components.

4. The method of claim 1, wherein applying the first coating to the first surface of the first component comprises cold spraying a material having a primary coating substance and a secondary coating substance onto the first surface.

5. The method of claim 4, wherein cold spraying the material onto the first surface comprises cold spraying a material including a melting point depressing agent as the secondary coating substance.

6. The method of claim 4, wherein applying the second coating to the second surface of the second component comprises cold spraying a material having a primary coating substance and a secondary coating substance onto the second surface.

7. The method of claim 6, wherein cold spraying the material onto the second surface comprises cold spraying a material including a melting point depressing agent as the secondary coating substance.

8. The method of claim 1, further comprising: finishing the bond between the first and second component.

9. The method of claim 8, wherein finishing the bond between the first component and the second component includes grinding the bond.

10. The method of claim 8, wherein finishing the bond between the first component and the second component includes polishing the bond.

11. The method of claim 8, wherein finishing the bond between the first component and the second component includes relieving stress at the bond.

12. A system for joining components comprising:
a cold spray coating device operatively connected to a coating source, the cold spray coating device depositing a first coating onto a first surface of a first component and a second coating on a second surface of a second component; and
a treating device housing the first and second components with the first surface of the first component being adjoined to the second surface of the second component to form an interface zone, the treating device, when operated:
creates a liquid layer at the interface zone, the liquid layer including a portion of the first and second coatings; and
solidifies the liquid layer to form a bond between the first and second components.

13. The system according to claim 12, wherein the treating device, when operated grows the liquid layer so as to include at least a portion of one of the first and second components.

14. The system according to claim 13, wherein the treating device, when operated, grows the liquid layer so as to include a portion of each of the first and second components.

15. The system according to claim 12, wherein the treating device, when operated, heat treats the first and second components to create the liquid layer.

16. The system according to claim 15, wherein the treating device, when operated, heat treats the first and second components at a temperature above a melting point of the first and second coatings and below a melting point of the first and second components.
